(19) United States
(12) Patent Application Publication
(10) Pub. No.: US 2006/0196707 A1
(43) Pub. Date: Sep. 7, 2006

(54) Robot hand with weighting device

(76) Inventors: Lobo Wang, Tucheng City (TW); Chihyu Chen, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/072,526

(22) Filed: Mar. 7, 2005

(51) Int. Cl. G01G 23/00; G01G 19/00

(52) U.S. Cl. 177/245

(57) ABSTRACT

The present invention provides a robot hand with weighting device including a holding part, a transmission valve, a carrier plate and a weighting device. The holding part is installed on the transmission valve to receive the power conveyed from the transmission valve. The weighting device is provided between the carrier plate and the transmission valve. The weighting device comprises a sensor base, an elastic part and a touching part. The sensor base is fixed on the carrier plate. A data transmission port is provided outside the sensor base. The data transmission port connects with a display device. The elastic part is mounted inside the sensor base. A resistance extensometer bridge is stuck on the elastic part. The touching part is set on the top of the elastic part. The touching part connects with the transmission valve. The robot hand with weighting device outputs the weight information in the process of carrying product due to the weighting device.

### BACKGROUND OF THE INVENTION

1. Field of the Invention

The present invention relates generally to a robot hand, and more especially to a robot hand with weighting device.

2. The Related Art

At present, the robot hand is used more and more popularly in the process of manufacture. In some occasions, operator need attain the weight information immediately but the conventional robot hand just holds product and its function is single.

### SUMMARY OF THE INVENTION

It is an object of the present invention to provide a robot hand with weighting device, which weighs the product at the same time when holding.

To attain the above object, the present invention provides a robot hand with weighting device including a holding part, a transmission valve, a carrier plate and a weighting device. The holding part is installed on the transmission valve to receive the power conveyed from the transmission valve. The weighting device is provided between the carrier plate and the transmission valve. The weighting device comprises a sensor base, an elastic part and a touching part. The sensor base is fixed on the carrier plate. A data transmission port is provided outside the sensor base. The data transmission port connects with a display device. The elastic part is mounted inside the sensor base. A resistance extensometer bridge is stuck on the elastic part. The touching part is set on the top of the elastic part. The touching part connects with the transmission valve.

As mentioned above, the robot hand with weighting device outputs the weight information in the process of carrying product due to the weighting device.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is a perspective view of a robot hand with weighting device of the invention.

FIG. 2 is an exploded perspective view of the robot hand with weighting device shown in FIG. 1.

### DETAILED DESCRIPTION OF THE PREFERRED EMBODIMENT

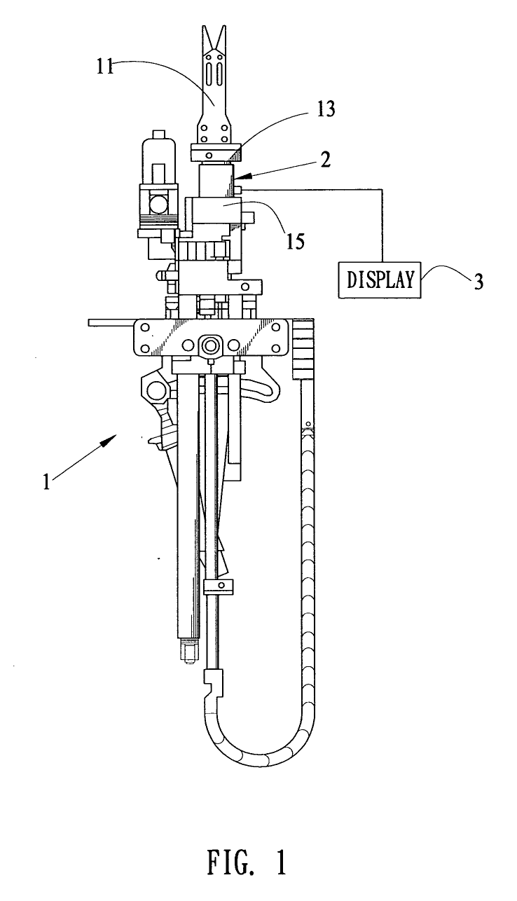

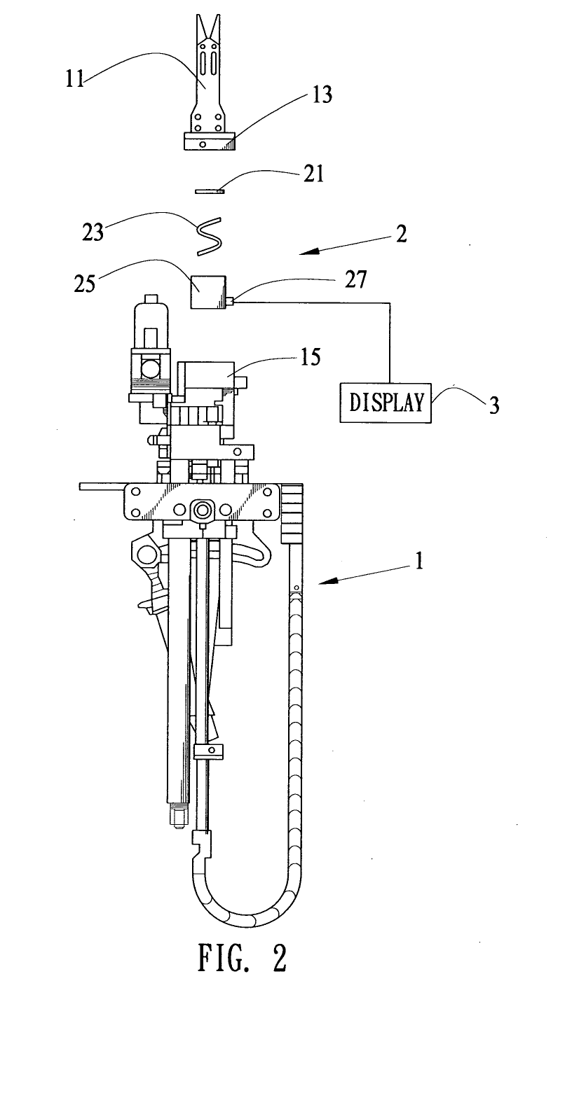

With reference to FIG. 1 and FIG. 2, a robot hand with weighting device in accordance with the present invention comprises a robot hand 1 and a weighting device 2.

The robot hand 1 includes a holding part 11, a transmission valve 13 and a carrier plate 15. The holding part 11 is installed on the transmission valve 13 to receive the power conveyed from the transmission valve 13. The weighting device 2 is provided between the carrier plate 15 and the transmission valve 13. The weighting device 2 comprises a sensor base 25, an elastic part 23 and a touching part 21. The sensor base 25 is fixed on the carrier plate 15. A data transmission port 27 is provided outside the sensor base 25. The elastic part 23 is mounted inside the sensor base 25. A resistance extensometer bridge (not shown) is stuck on the elastic part 23. The touching part 21 is set on the top of the elastic part 23 and connects with the transmission valve 13.

In application, when the robot hand carries a product, the holding part 11 holds the product and make the product in a vertical condition, in the same time, the weight of the product is transmitted to the elastic part 23 through the holding part 11, the transmission valve 13 and the touching part 21. Under the weight of the product, the elastic part 23 is deformed and the resistance extensometer bridge stuck on the elastic part 23 lose balance, so that an electric signal proportioned to weight of the product is output. After the electric signal is amplified, filtered and converted, the weight information is sent to a display device 3 through the data transmission port 27.

Since the technical of the resistance extensometer bridge and amplifying, filtering and converting circuits is well known to those skilled in the art, it is not further described in the specification.

Although a particular embodiment of the invention has been described in detail for purposes of illustration, additional advantages and modifications will readily appear to those skilled in the art, and various modifications and enhancements may be made without departing from the spirit and scope of the invention. Accordingly, the invention is not to be limited except as by the appended claims.

What is claimed is:

1. A robot hand with weighting device comprising:
a carrier plate, a transmission valve, a holding part and a weighting device, the holding part installed on the transmission valve to receive the power conveyed from the transmission valve, the weighting device provided between the carrier plate and the transmission valve; wherein
the weighting device comprises a sensor base, an elastic part and a touching part; the sensor base is fixed on the carrier plate; the elastic part is mounted inside the sensor base; the touching part is set on the top of the elastic part and connects with the transmission valve;
a data transmission port is provided outside the sensor base and connects with a display device; and
a resistance extensometer bridge is stuck on the elastic part.
